(19) United States
(12) Patent Application Publication
(10) Pub. No.: US 2013/0050599 A1
(43) Pub. Date: Feb. 28, 2013

(54) SOLAR PANEL, LIQUID CRYSTAL DISPLAY SYSTEM, AND METHOD FOR CONTROLLING SOLAR PANEL

(71) Applicants: Hiroshi Yoshida, Osaka-shi (JP); Yukihide Kohtoku, Osaka-shi (JP)

(72) Inventors: Hiroshi Yoshida, Osaka-shi (JP); Yukihide Kohtoku, Osaka-shi (JP)

(73) Assignee: SHARP KABUSHIKI KAISHA, Osaka-shi, Osaka (JP)

(21) Appl. No.: 13/695,806

(22) PCT Filed: Apr. 14, 2011
(86) PCT No.: PCT/JP2011/002214

§ 371 Date: Nov. 2, 2012

(30) Foreign Application Priority Data
Jul. 8, 2010 (JP) 2010-156147

(51) Int. Cl. G02F 1/133; G02F 1/13357

(52) U.S. Cl. 349/33

(57) ABSTRACT

A solar panel is provided which can be satisfactorily used as an information medium for advertising, announcement, etc. without a decrease in the efficiency of power generation. The solar panel includes a liquid crystal display panel 100 including a memory liquid crystal layer 36 between electrodes, and a solar cell 200. When the solar cell 200 performs power generation, the memory liquid crystal layer 36 is changed to an optically transparent state. On the other hand, when the solar cell 200 does not perform power generation, pixels in a light scattering state are formed in a predetermined portion of the memory liquid crystal layer 36, thereby performing light display, and pixels in an optically transparent state are formed in the other portion of the memory liquid crystal layer 36, thereby performing dark display, whereby an image including a combination of the light display and the dark display is formed on the liquid crystal display panel 100.

### TECHNICAL FIELD

The present invention relates to solar panels with a display function capable of displaying images except during power generation, liquid crystal display systems with a solar cell which perform power generation using the solar cell and display images except during power generation, and methods for controlling the solar panels.

### BACKGROUND ART

Solar panels have in recent years rapidly become widespread and penetrated into a variety of fields, such as compact electronic devices (e.g., an electronic calculator etc.) (small-size solar panels are used), solar panels which are attached to roof for home use (see PATENT DOCUMENT 1), and large-area solar cell power generation systems used in large power generation plants.

The widespread use of solar cells has led to an increase in importance of their outward appearance. There is an increasing demand for a technique of taking advantage of the large-area front surface of the solar panel for any purpose other than power generation.

Specifically, if characters, graphics, etc. are displayed on the front surface of the solar panel, the solar panel may be used as an information medium for advertising, announcement, etc.

For example, PATENT DOCUMENT 2 describes a solar panel including solar cell modules having arbitrarily colored surfaces. The solar panel can display a desired pattern (e.g., characters, graphics, etc.) by combining the solar cell modules having different colors.

For example, PATENT DOCUMENT 3 describes a solar panel including unit solar cell elements having two or more colors on the light receiving surfaces thereof. The unit solar cell elements are arranged in a mosaic to form a specific pattern of characters, symbols, or graphics.

### CITATION LIST

### Patent Documents

PATENT DOCUMENT 1: Japanese Patent Publication No. 2001-295437
PATENT DOCUMENT 2: Japanese Patent Publication No. 2001-237449
PATENT DOCUMENT 3: Japanese Patent Publication No. 2006-179380

### SUMMARY OF THE INVENTION

### Technical Problem

However, when characters, pictures, etc. for corporate advertising are provided on the entire surface of a solar panel, if the pattern is produced on the front surface of the solar panel by printing, which is a commonly used technique, the light transmission of the solar panel decreases, and therefore, the efficiency of power generation disadvantageously deteriorates.

The solar panel in which a combination of solar cell modules having different colors are arranged to form any graphic pattern (desired colors are imparted to the front surfaces of the solar panel modules) can display only a fixed pattern. Therefore, this solar panel is disadvantageously not sufficiently effective as an information medium for advertising, announcement, etc.

It is with respect to these and other considerations that the present invention has been made. It is an object of the present invention to provide a solar panel which is sufficiently effective as an information medium for advertising, announcement, etc. without a decrease in the efficiency of power generation of the solar cell, a liquid crystal display system with a solar cell which performs power generation using the solar cell, and also serves as an information medium for advertising, announcement, etc. to display an image except during power generation, and a method for controlling the solar panel.

### Solution to the Problem

To achieve the object, a solar panel or a liquid crystal display system according to the present invention includes a solar cell, and a liquid crystal display panel including a memory liquid crystal layer between electrodes and facing the solar cell. When the solar cell performs power generation (first state), the memory liquid crystal layer is changed to an optically transparent state. On the other hand, when the liquid crystal display panel displays an image (second mode), pixels in a light scattering state are formed to scatter incident light, thereby performing light display in a predetermined portion of the liquid crystal display panel, and pixels in an optically transparent state are formed, thereby performing dark display based on the color of the solar cell in the other portion of the liquid crystal display panel, whereby an image including a combination of the light display and the dark display is formed on the liquid crystal display panel. Thus, the solar panel or the liquid crystal display system is used as an information medium for advertising, announcement, etc.

Specifically, a solar panel according to a first aspect of the present invention includes a liquid crystal display panel including a first transparent substrate on which a first electrode is formed, a second transparent substrate on which a second electrode is formed and which faces the first transparent substrate, and a light scattering liquid crystal layer enclosed between the first and second transparent substrates, a solar cell provided on a back side of the liquid crystal display panel, facing the liquid crystal display panel, and a liquid crystal controller configured to control an aligned state of liquid crystal. The liquid crystal controller, in a first mode in which the solar cell performs power generation, causes the light scattering liquid crystal layer of the liquid crystal display panel to be in an optically transparent state so that external light is transmitted through the light scattering liquid crystal layer to illuminate the solar cell. The liquid crystal controller, in a second mode in which the liquid crystal display panel displays an image, forms an electric field between the first and second electrodes in a predetermined portion of the liquid crystal display panel to cause the light scattering liquid crystal layer to be in the optically transparent state, thereby performing dark display, and does not form an electric field between the first and second electrodes in the other portion of the liquid crystal display panel, to cause the light scattering liquid crystal layer to be in a light scattering state to scatter external light, thereby performing light display, whereby a light-and-dark image including a combination of the light display and the dark display is displayed on the liquid crystal display panel.

As used herein, the light display means color display which is recognized based on scattered light, e.g., white display. The dark display means color display which is recognized based on external light which is transmitted through the light scattering liquid crystal layer and is not reflected, e.g., black display or gray display.

The light scattering liquid crystal layer means a liquid crystal layer in which, when a voltage is not applied, liquid crystal molecules are oriented in random directions, and therefore, incident light is scattered, so that the liquid crystal layer appears milky or turbid (the liquid crystal shutter is closed), and when a voltage is applied, liquid crystal molecules are oriented in parallel to an electric field, and therefore, light is transmitted (the liquid crystal shutter is open).

With this configuration, for example, during the day, the memory liquid crystal layer of the liquid crystal display panel is caused to be in the optically transparent state, whereby the solar cell is allowed to sufficiently perform power generation. On the other hand, for example, around sunset, if the solar cell does not or hardly perform power generation, pixels in the light scattering state are formed to perform light display in a predetermined portion, and pixels in the optically transparent state are formed to perform dark display based on the color of the solar cell in the other portion, whereby an image including a combination of the light display and the dark display can be formed on the liquid crystal display panel. Therefore, the solar panel can be satisfactorily used as an information medium for advertising, announcement, etc. without a decrease in power generation of the solar cell.

The solar panel preferably receives data containing at least one of video data and audio data of a digital signage content via the Internet or digital broadcast waves of a broadcast station, and displays the received digital signage content on the liquid crystal display panel.

With this configuration, the liquid crystal display panel displays a digital signage content transmitted via the Internet or digital broadcast waves. Therefore, an advertisement which is updated periodically can be presented to rail passengers in a station or shoppers in a shop etc. Thus, the solar panel can be satisfactorily used as an information medium for advertising, announcement, etc.

The solar panel preferably includes a rechargeable battery configured to store power generated by the solar cell, a voltage detector configured to detect a voltage generated by the solar cell, and a mode switch configured to compare the voltage detected by the voltage detector with a predetermined threshold voltage, and if the detected voltage is higher than the threshold voltage, cause the solar panel to be in a charge mode in which the rechargeable battery is charged with the power generated by the solar cell, and if the detected voltage is lower than the threshold voltage, cause the solar panel to be in a display mode in which the liquid crystal display panel displays an image.

With this configuration, by detecting the voltage generated by the solar cell, the solar panel can be automatically switched between the charge mode in which the rechargeable battery is charged with the generated power and the display mode in which the liquid crystal display panel displays an image.

Alternatively, the solar panel may include a rechargeable battery configured to store power generated by the solar cell, a time detector configured to detect current time, and a mode switch configured to, if the time detected by the time detector is in a predetermined time period, cause the solar panel to be in a charge mode in which the rechargeable battery is charged with the power generated by the solar cell, and if the detected time is not in the predetermined time period, cause the solar panel to be in a display mode in which the liquid crystal display panel displays an image.

With this configuration, by detecting the time, the solar panel can be automatically switched between the charge mode in which the rechargeable battery is charged with the generated power and the display mode in which the liquid crystal display panel displays an image.

The solar panel preferably includes a backlight including a plurality of light emitting units provided on a back side of the solar cell, facing the solar cell, and configured to emit illuminating light toward the liquid crystal display panel, and an on/off controller configured to control on and off of each of the light emitting units. The solar cell preferably includes an opening configured to transmit the illuminating light emitted by the backlight toward the liquid crystal display panel. The on/off controller, in the second mode, preferably turns off the light emitting unit or units of the backlight corresponding to the other portion of the liquid crystal display panel on which dark display is formed, and turns on the light emitting unit or units of the backlight corresponding to the predetermined portion of the liquid crystal display panel in which light display is formed.

If the overall intensity of external light illuminating the liquid crystal display panel is low, light display performed by scattered light is blurred, and therefore, the contrast ratio is likely to decrease. With this configuration, even when the intensity of external light is low, the light emitting unit or units of the backlight corresponding to a portion in which light display is formed are turned on to supplement the light display, whereby the contrast of the light display and the dark display can be emphasized.

The solar panel preferably includes a plurality of photosensors included in the liquid crystal display panel and configured to detect intensity of external light in each predetermined region of a display portion including a plurality of display pixels arranged in a matrix, and an image correction unit configured to correct an image displayed in the display portion, based on a distribution of the intensity of the external light in the display portion which is obtained based on a result of the detection of the photosensors.

When the intensity of external light emitted to the liquid crystal display panel is high in a region of the liquid crystal display panel, light display in that region is more emphasized than in the other region, and therefore, the contrast ratio is likely to differ between that region and the other region. With this configuration, in a region having a high external light intensity, the liquid crystal molecules of the memory liquid crystal layer are changed from the random state to an aligned state in which the liquid crystal molecules are slightly optically transparent, whereby the emphasis on light display can be reduced. Therefore, the viewer can recognize an image having an original or intended contrast over the entire screen.

The solar panel preferably includes a backlight including a plurality of light emitting units provided on a back side of the solar cell, facing the solar cell, and configured to emit illuminating light toward the liquid crystal display panel, an on/off controller configured to control on and off of each of the light emitting units, and a plurality of photosensors included in the liquid crystal display panel and configured to detect intensity of external light in each predetermined region of a display portion including a plurality of display pixels arranged in a matrix. The solar cell preferably has an opening configured to transmit the illuminating light emitted by the backlight toward the liquid crystal display panel. The on/off controller preferably turns on the light emitting unit or units corresponding to a region for which the corresponding photosensor has detected that the intensity of the external light emitted to the region of the liquid crystal display panel is lower than that in the other region.

When the intensity of external light emitted to the liquid crystal display panel is low in a region of the liquid crystal display panel, light display in that region is more blurred than in the other region, and therefore, the contrast ratio is likely to differ between that region and the other region. With this configuration, in a region having a low external light intensity, the on/off controller controls and turns on the light emitting unit or units corresponding to that region of the backlight, whereby light of the backlight is scattered by the liquid crystal molecule in the random state to produce scattered light, with which the light display is supplemented, and therefore, the contrast of the light display and the dark display can be emphasized.

The solar cell preferably includes an LED illumination unit including a plurality of LED elements provided on a back side of the solar cell, facing the solar cell. The solar cell preferably has an opening configured to transmit LED light emitted by the LED element toward the liquid crystal display panel. An image is preferably formed on the liquid crystal display panel by illumination with the LED light of the plurality of LED elements through the opening, except in the first and second modes.

With this configuration, for example, during the night, the LED light of the LED elements is transmitted through the opening formed in the solar cell, whereby an image can be formed by a plurality of LED light beams on the liquid crystal display panel. Therefore, the solar panel can be satisfactorily used as an information medium for advertising, announcement, etc. during the night.

The solar panel preferably includes a rechargeable battery configured to store power generated by the solar cell. The LED elements of the LED illumination unit are preferably driven by the power stored in the rechargeable battery.

With this configuration, the power generated by the solar cell is stored in the rechargeable battery, and the LED elements are turned on by the power stored in the rechargeable battery, and therefore, energy can be efficiently used.

The light scattering liquid crystal layer is preferably a memory liquid crystal layer. As used herein, the memory liquid crystal layer means a liquid crystal which has a plurality of optical states and can maintain a particular state in the absence of an electric field (memory function).

With this configuration, the memory function which maintains the aligned state of the liquid crystal molecules of the memory liquid crystal layer even in the absence of an applied electric field can maintain display of a light-and-dark image on the liquid crystal display panel, whereby the reduction of power consumption can be promoted.

The solar cell may be a silicon solar cell. With this configuration, for example, in the case of a crystalline silicon solar cell, black or bluish-purple display can be provided as the dark display based on the color of the solar cell. For example, in the case of an amorphous silicon solar cell, brown display can be provided. By appropriately selecting the type of the silicon solar cell, display having various atmospheres can be provided. Therefore, the solar panel can be satisfactorily used as an information medium for advertising, announcement, etc.

The solar cell may be a dye-sensitized solar cell. With this configuration, the dye-sensitized solar cell is capable of being designed to have various colors by appropriately selecting predetermined dyes which are to be adsorbed by the semiconductor electrode. Display having various atmospheres based on the color of the solar cell can be provided. Therefore, the solar panel can be satisfactorily used as an information medium for advertising, announcement, etc.

A liquid crystal display system according to a second aspect of the present invention includes a liquid crystal display panel including a first transparent substrate provided on a front side and on which a first electrode is formed, a second transparent substrate on which a second electrode is formed and which is provided on a back side of the first transparent substrate, facing the first transparent substrate, and a light scattering liquid crystal layer enclosed between the first and second transparent substrates, a liquid crystal controller configured to control an aligned state of liquid crystal, and a solar cell provided on a back side of the second transparent substrate, facing the second transparent substrate. The liquid crystal controller, in a first mode in which the solar cell performs power generation, causes the light scattering liquid crystal layer to be in an optically transparent state so that external light is transmitted through the light scattering liquid crystal layer to illuminate the solar cell. The liquid crystal controller, in a second mode in which the liquid crystal display panel displays an image, forms an electric field between the first and second electrodes in a predetermined portion of the light scattering liquid crystal layer to cause the light scattering liquid crystal layer to be in the optically transparent state, thereby performing dark display, and does not form an electric field between the first and second electrodes in the other portion of the light scattering liquid crystal layer, to cause the light scattering liquid crystal layer to be in a light scattering state to scatter external light, thereby performing light display, whereby a light-and-dark image including a combination of the light display and the dark display is displayed.

The liquid crystal display system preferably receives data containing at least one of video data and audio data of a digital signage content via the Internet or digital broadcast waves of a broadcast station, and displays the received digital signage content on the liquid crystal display panel.

The liquid crystal display system preferably includes a rechargeable battery configured to store power generated by the solar cell, a voltage detector configured to detect a voltage generated by the solar cell, and a mode switch configured to compare the voltage detected by the voltage detector with a predetermined threshold voltage, and if the detected voltage is higher than the threshold voltage, cause the liquid crystal display system to be in a charge mode in which the rechargeable battery is charged with the power generated by the solar cell, and if the detected voltage is lower than the threshold voltage, cause the liquid crystal display system to be in a display mode in which the liquid crystal display panel displays an image.

The liquid crystal display system preferably includes a rechargeable battery configured to store power generated by the solar cell, a time detector configured to detect current time, and a mode switch configured to, if the time detected by the time detector is in a predetermined time period, cause the liquid crystal display system to be in a charge mode in which the rechargeable battery is charged with the power generated by the solar cell, and if the detected time is not in the predetermined time period, cause the liquid crystal display system to be in a display mode in which the liquid crystal display panel displays an image.

The liquid crystal display system preferably includes a backlight including a plurality of light emitting units provided on a back side of the solar cell, facing the solar cell, and configured to emit illuminating light toward the liquid crystal display panel, and an on/off controller configured to control on and off of each of the light emitting units. The solar cell preferably includes an opening configured to transmit the illuminating light emitted by the backlight toward the liquid crystal display panel. The on/off controller, in the second mode, preferably turns off the light emitting unit or units of the backlight corresponding to the other portion of the liquid crystal display panel on which dark display is formed, and turns on the light emitting unit or units of the backlight corresponding to the predetermined portion of the liquid crystal display panel in which light display is formed.

The liquid crystal display system preferably includes a plurality of photosensors included in the liquid crystal display panel and configured to detect intensity of external light in each predetermined region of a display portion including a plurality of display pixels arranged in a matrix, and an image correction unit configured to correct an image displayed in the display portion, based on a distribution of the intensity of the external light in the display portion which is obtained based on a result of the detection of the photosensors.

The liquid crystal display system preferably includes a backlight including a plurality of light emitting units provided on a back side of the solar cell, facing the solar cell, and configured to emit illuminating light toward the liquid crystal display panel, an on/off controller configured to control on and off of each of the light emitting units, and a plurality of photosensors included in the liquid crystal display panel and configured to detect intensity of external light in each predetermined region of a display portion including a plurality of display pixels arranged in a matrix. The solar cell preferably has an opening configured to transmit the illuminating light emitted by the backlight toward the liquid crystal display panel. The on/off controller preferably turns on the light emitting unit or units corresponding to a region for which the corresponding photosensor has detected that the intensity of the external light emitted to the region of the liquid crystal display panel is lower than that in the other region.

The liquid crystal display system preferably includes an LED illumination unit including a plurality of LED elements provided on a back side of the solar cell, facing the solar cell. The solar cell preferably has an opening configured to transmit LED light emitted by the LED element toward the liquid crystal display panel. An image is preferably formed on the liquid crystal display panel by illumination with the LED light of the plurality of LED elements through the opening except in the first and second modes.

The light scattering liquid crystal layer is preferably a memory liquid crystal layer.

A solar panel control method according to a third aspect of the present invention is a method for controlling a solar panel including a liquid crystal display panel including a first transparent substrate on which a first electrode is formed, a second transparent substrate on which a second electrode is formed and which faces the first transparent substrate, and a light scattering liquid crystal layer enclosed between the first and second transparent substrates, a solar cell provided on a back side of the liquid crystal display panel, facing the liquid crystal display panel, and a liquid crystal controller configured to control an aligned state of liquid crystal. The method includes, in a first mode in which the solar cell performs power generation, causing the light scattering liquid crystal layer of the liquid crystal display panel to be in an optically transparent state so that external light is transmitted through the light scattering liquid crystal layer to illuminate the solar cell, and in a second mode in which the liquid crystal display panel displays an image, forming an electric field between the first and second electrodes in a predetermined portion of the liquid crystal display panel to cause the light scattering liquid crystal layer to be in the optically transparent state, thereby performing dark display, and not forming an electric field between the first and second electrodes in the other portion of the liquid crystal display panel, to cause the light scattering liquid crystal layer to be in a light scattering state to scatter external light, thereby performing light display, and thereby, displaying a light-and-dark image including a combination of the light display and the dark display on the liquid crystal display panel.

### Advantages of the Invention

According to the present invention, the light scattering liquid crystal layer can be caused to be in the optically transparent state, thereby allowing external light to enter the solar cell, whereby the solar cell can efficiently performs power generation. When the liquid crystal display panel displays an image, the light scattering liquid crystal layer in a predetermined portion of the liquid crystal display panel is caused to be in the light scattering state, thereby performing light display, and the light scattering liquid crystal layer in the other portion of the liquid crystal display panel is caused to be in the optically transparent state, thereby performing dark display based on the color of the solar cell, whereby a light-and-dark image including a combination of the light display and the dark display can be displayed on the liquid crystal display panel. Therefore, the solar panel or the liquid crystal display system can be used as an information medium for advertising, announcement, etc.

### BRIEF DESCRIPTION OF THE DRAWINGS

FIG. 1 is a block diagram for briefly describing a solar panel according to this embodiment.

FIG. 2 is a cross-sectional view of the solar panel of this embodiment.

FIG. 3 is a circuit diagram of an active matrix configuration of a liquid crystal display panel.

FIG. 4A is a diagram schematically showing a process of forming a polycrystalline silicon film on an array substrate.

FIG. 4B is a diagram schematically showing a process of forming an active layer of thin film transistors.

FIG. 4C is a diagram schematically showing a process of forming gate electrodes.

FIG. 4D is a diagram schematically showing a process of forming a first interlayer insulating film.

FIG. 4E is a diagram schematically showing a process of forming source/drain electrodes.

FIG. 4F is a diagram schematically showing a process of forming pixel electrodes.

FIG. 5 is a block diagram of a digital signage system using the Internet.

FIG. 6 is a flowchart of an example use in which the solar panel is switched between a charge mode and a display mode by comparing a voltage generated by a solar cell and a threshold voltage.

FIG. 7A is a cross-sectional view for describing an example use in which the solar cell performs power generation.

FIG. 7B is a cross-sectional view for describing an example use in which the liquid crystal display panel displays an image while the solar cell does not perform power generation.

FIG. 8 is a block diagram for briefly describing the solar panel which is switched between the charge mode and the display mode, depending on the time.

FIG. 9 is a flowchart of an example use in which the current time is detected so that the solar panel is switched between the charge mode and the display mode.

FIG. 10 is a diagram for describing a display form in which a backlight including a plurality of light emitting units is provided, and a light emitting unit(s) corresponding to a portion in which dark display is formed is turned off while a light emitting unit(s) corresponding to a portion in which light display is formed is turned on.

FIG. 11 is a block diagram for describing a configuration in which a plurality of photosensors are provided in a display portion of the liquid crystal display panel.

FIG. 12 is a diagram for describing a configuration in which an LED illumination unit is formed on the back side of the solar cell so that an image is displayed using LED light.

FIG. 13 is a cross-sectional view of a solar panel in which a dye-sensitized solar cell is provided on the back side of a liquid crystal display panel, facing the liquid crystal display panel.

### DESCRIPTION OF EMBODIMENTS

### First Embodiment

Embodiments of the present invention will be specifically described hereinafter with reference to the accompanying drawings. The embodiments are for the purpose of facilitating understanding of the principle of the present invention. The scope of the present invention is not intended to be limited to the embodiments below. Those skilled in the art will make substitutions to the embodiments when necessary without departing the scope of the present invention.

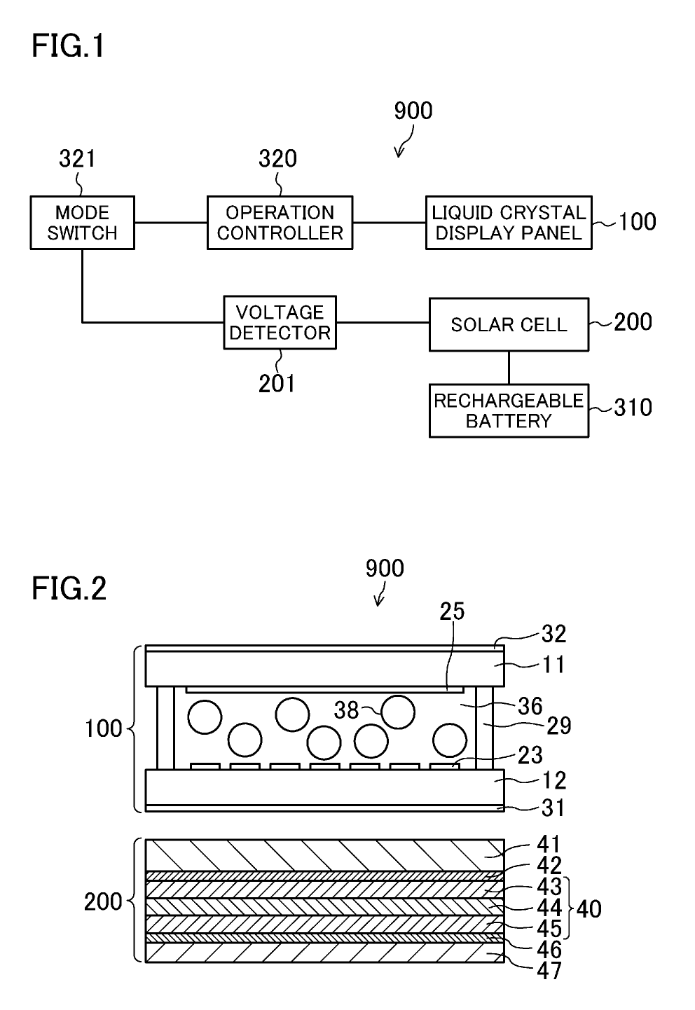

FIG. 1 is a block diagram for briefly describing a solar panel 900 according to this embodiment. As shown in FIG. 1, the solar panel 900 includes a liquid crystal display panel 100 which includes a light scattering liquid crystal layer sandwiched between substrates, a solar cell 200 which is provided on the back side of the liquid crystal display panel 100, facing the liquid crystal display panel 100, a liquid crystal controller 320, a voltage detector 201 which detects a voltage generated by the solar cell 200, a rechargeable battery 310, and a mode switch 321. The place where the solar cell 200 is placed is not particularly limited and may be, for example, a wall of an office building.

The liquid crystal controller 320 controls a state of the liquid crystal of the liquid crystal display panel 100 when the solar cell 200 performs power generation (first mode) and when the liquid crystal display panel 100 displays an image (second mode).

The mode switch 321 monitors the voltage generated by the solar cell 200, and compares the generated voltage with a threshold voltage which is used to determine whether it is day or night (after sunset), thereby determining whether to cause the solar panel 900 to be in a charge mode (first mode) in which the rechargeable battery 310 is charged with power generated by the solar cell 200 or a display mode (second mode) in which the solar cell 200 does not perform power generation and the liquid crystal display panel 100 displays an image, and automatically changing the modes.

The rechargeable battery 310 is charged with power generated by the solar cell 200. Examples of the rechargeable battery 310 include, but are not particularly limited to, secondary batteries (e.g., a lead-acid battery, a nickel-hydrogen battery, a lithium-ion battery, etc.) or capacitors.

FIG. 2 is a cross-sectional view of the solar panel 900 of this embodiment. Firstly, the liquid crystal display panel 100 will be described. The liquid crystal display panel 100, which is of the active matrix type, includes a first transparent substrate 11 provided on the front side, a second transparent substrate 12 provided on the back side, facing the first transparent substrate 11, and a memory liquid crystal layer 36 (light scattering liquid crystal layer) sandwiched between the first and second transparent substrates 11 and 12. In order to prevent leakage of the memory liquid crystal layer 36, a sealing material 29 is used to seal a perimeter of the first and second transparent substrates 11 and 12. Examples of the memory liquid crystal layer 36 include, but are not particularly limited to, ferroelectric liquid crystal and cholesteric liquid crystal, which have excellent memory characteristics.

For example, a counter electrode 25 (first electrode) is formed on an inner or back surface of the first transparent substrate 11. For example, pixel electrodes 23 (second electrodes) are formed on an inner surface (i.e., a front surface) of the second transparent substrate 12. An upper polarizing plate 32 and a lower polarizing plate 31 which are typically of the absorptive type and are arranged in crossed Nicols, are formed on outer sides of the first and second transparent substrates 11 and 12.

The first and second transparent substrates 11 and 12 may be, but not particularly limited to, an optically transparent substrate of glass, quartz, etc. The pixel electrode 23 and the counter electrode 25 are formed of an optically transparent conductive material, such as indium tin oxide (ITO) etc.

Next, a structure of the solar cell 200 will be described. A first transparent electrode 42 is formed on the back side of the transparent insulating substrate 41. The transparent insulating substrate 41 is formed of, for example, optically transparent glass. The first transparent electrode 42 is formed of, for example, SnO₂. A microcrystalline p-type silicon layer 43, a microcrystalline i-type silicon layer 44, and a microcrystalline n-type silicon layer 45 are formed on the back side of the first transparent electrode 42. The p-type silicon layer 43, the i-type silicon layer 44, and the n-type silicon layer 45 form a photoelectric conversion layer 40. An example thickness of the photoelectric conversion layer 40 is, but not particularly limited to, 100-600 nm. A second transparent electrode 46 is formed on the back side of the microcrystalline n-type silicon layer 45. The second transparent electrode 46 is, for example, a ZnO layer. A back electrode 47 which is, for example, an Al or Ag film is formed on the back side of the second transparent electrode 46. In the solar cell 200, light (e.g., sunlight etc.) enters through the transparent insulating substrate 41 and is converted into electricity by the photoelectric conversion layer 40 having the pin structure, whereby power is generated.

Note that the photoelectric conversion layer 40 has a pin structure in which the p-type silicon layer 43, the i-type silicon layer 44, and the n-type silicon layer 45 are successively formed (the p-type silicon layer 43 is the closest to the first transparent electrode 42). Alternatively, an n-type silicon layer, an i-type silicon layer, and a p-type silicon layer may be successively formed to form an nip structure. The photoelectric conversion layer 40 is formed of microcrystalline silicon. The present invention is not limited to this embodiment. Alternatively, for example, the photoelectric conversion layer 40 may have a pin structure in which an amorphous p-type silicon layer, an amorphous i-type silicon layer, and an amorphous n-type silicon layer are successively formed (the amorphous p-type silicon layer is the closest to the first transparent electrode 42). Alternatively, the photoelectric conversion layer 40 may have an nip structure in which an amorphous n-type silicon layer, an amorphous i-type silicon layer, and an amorphous p-type silicon layer are successively formed (the amorphous n-type silicon layer is the closest to the first transparent electrode 42). The photoelectric conversion layer 40 is not limited to the single type formed of amorphous silicon or microcrystalline silicon. Alternatively, for example, the photoelectric conversion layer 40 may be, for example, of the tandem type including a photoelectric conversion layer of amorphous silicon and a photoelectric conversion layer of microcrystalline silicon which are provided on top of each other. The photoelectric conversion layer 40 of the tandem type has about 1.5 times as high a conversion efficiency as that of the single type. An anti-reflection layer may be formed on a light receiving surface of the photoelectric conversion layer 40 in order to increase the light reception efficiency, and the first transparent electrode 42 may be formed on a surface of the anti-reflection layer. The anti-reflection layer is formed of, for example, titanium oxide, silicon dioxide, silicon nitride, etc.

The liquid crystal controller 320 of FIG. 1, when the solar cell 200 performs power generation (first mode), causes the memory liquid crystal layer 36 of the liquid crystal display panel 100 to be in an optically transparent state so that external light is transmitted through the memory liquid crystal layer 36 to illuminate the solar cell 200, whereby the solar cell 200 is allowed to perform power generation. The liquid crystal controller 320 of FIG. 1, when the liquid crystal display panel 100 displays an image (second mode), forms an electric field between the pixel electrode 23 and the counter electrode 25 in a predetermined portion of the liquid crystal display panel 100 to cause the memory liquid crystal layer 36 to be in an optically transparent state, whereby dark display is performed. At the same time, the liquid crystal controller 320 does not form an electric field between the two substrates in the other portion of the liquid crystal display panel 100 to cause the memory liquid crystal layer 36 to be a light scattering state, whereby external light is scattered, i.e., light display is performed. Thus, the liquid crystal display panel 100 is allowed to display a light-and-dark image including a combination of the light display and the dark display.

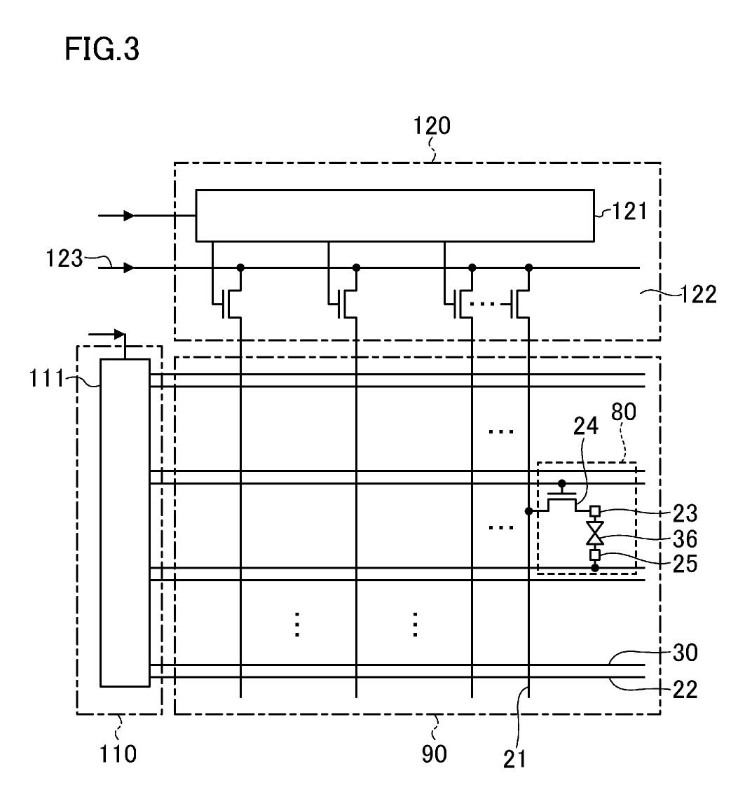

FIG. 3 is a circuit diagram of an active matrix configuration of the liquid crystal display panel 100. The liquid crystal display panel 100 includes a display portion 90 in which a plurality of display pixels 80 are formed, a scanning line drive circuit 110, and a signal line drive circuit 120. The scanning line drive circuit 110 and the signal line drive circuit 120 are integrally formed with signal lines 21, scanning lines 22, and the pixel electrodes 23 on the second transparent substrate 12.

In the display portion 90, the scanning lines 22 and the signal lines 21 intersecting the scanning lines 22 are arranged in a matrix on the second transparent substrate 12 with an insulating film (not shown) being interposed between the signal lines 21 and the scanning lines 22. The display pixel 80 is provided at each of intersection portions of the signal lines 21 and the scanning lines 22. The display pixel 80 includes the pixel electrode 23, a thin film transistor (TFT) 24, the counter electrode 25, and the memory liquid crystal layer 36. The source of the thin film transistor 24 is connected to the signal line 21, the gate is connected to the scanning line 22, and the drain is connected to the pixel electrode 23.

The scanning line drive circuit 110 includes a buffer circuit (not shown), a shift register 111, etc. The scanning line drive circuit 110 successively outputs a scanning signal to the scanning lines 22 based on a control signal supplied from an external drive circuit (not shown). For example, when a moving image (e.g., a clock etc.) is displayed on the liquid crystal display panel 100, the scanning line drive circuit 110 turns control signal lines 30 off, and successively outputs a scanning signal to the scanning lines 22 as with a typical active matrix liquid crystal display panel. On the other hand, for example, when a still image (e.g., symbols indicating types of weather (sunny, rain, snow, etc.)) is displayed on the liquid crystal display panel 100, the scanning line drive circuit 110 turns the scanning lines 22 off and the control signal lines 30 on.

The signal line drive circuit 120 includes an analog switch 122, a shift register 121, etc. The signal line drive circuit 120 receives a control signal, and a video signal through a video bus 123, from an external drive circuit (not shown). In the signal line drive circuit 120, the shift register 121 supplies an on/off signal to the analog switch 122, whereby the video signal supplied from the video bus 123 is sampled to the signal lines 21 with predetermined timing.

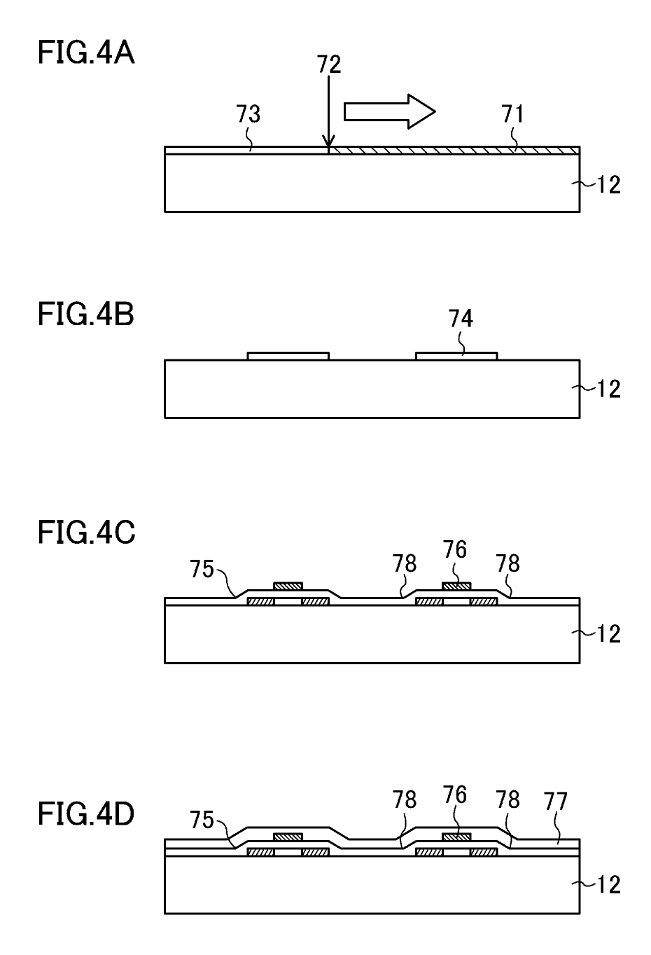

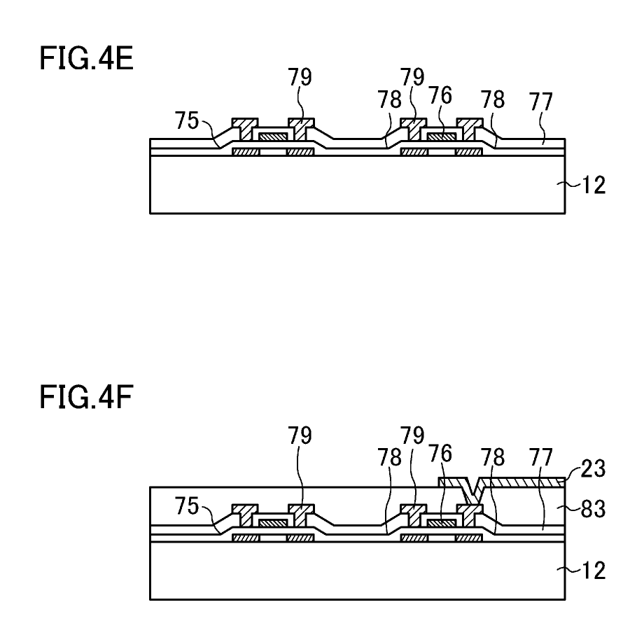

Next, a process for manufacturing the solar panel 900 will be described. Firstly, an example process for manufacturing the liquid crystal display panel 100 will be described. FIGS. 4A-4F are diagrams schematically showing the process for manufacturing the liquid crystal display panel 100. As shown in FIG. 4A, an amorphous silicon thin film 71 is deposited on the second transparent substrate 12 of glass etc. by plasma-enhanced CVD. The amorphous silicon thin film 71 is converted into a polycrystalline form by annealing using a laser device. A laser beam 72 from the laser device is moved in a direction indicated by an arrow in FIG. 4A. A region irradiated with the laser beam 72 is crystallized to form a polycrystalline silicon film 73. Next, as shown in FIG. 4B, the polycrystalline silicon film 73 is patterned by photolithography to form an active layer 74 for thin film transistors. Next, as shown in FIG. 4C, a gate insulating film 75 which is a silicon oxide film is formed by plasma-enhanced CVD, and thereafter, a Mo—W alloy film is formed by sputtering, and patterning is performed on the Mo—W alloy film, whereby gate electrodes 76 are formed. Scanning lines are formed at the same time as the patterning. After the formation of the gate electrodes 76, an impurity is implanted by an ion doping technique using the gate electrodes 76 as a mask to form source/drain regions 78 for the thin film transistors.

Next, as shown in FIG. 4D, a first interlayer insulating film 77 which is a silicon oxide film is formed on the gate electrode 76 by plasma-enhanced CVD. Next, as shown in FIG. 4E, contact holes are formed in the first interlayer insulating film 77 and the gate insulating film 75, and thereafter, an aluminum film is formed by sputtering, and patterning is performed on the aluminum film, whereby source/drain electrodes 79 are formed. At the same time, signal lines are formed. Next, as shown in FIG. 4F, a second interlayer insulating film 83 is formed on the aluminum film. Thereafter, contact holes are formed in the second interlayer insulating film 83, an aluminum thin film is formed, and patterning is performed on the aluminum thin film, whereby the pixel electrodes 23 are formed. Thereafter, the second transparent substrate 12, and a counter substrate on which a counter electrode (not shown) is formed, are placed to face each other, a perimeter of the substrates is sealed by a sealing material. A memory liquid crystal composition is injected into a space between the substrates and enclosed by the sealing material. Thus, the liquid crystal display panel 100 is formed.

Next, an example process for manufacturing the solar cell 200 shown in FIG. 2 will be described. Initially, the transparent insulating substrate 41 is placed in an atmospheric pressure thermal CVD device. A film of SnO₂ is formed on the transparent insulating substrate 41 to form the first transparent electrode 42. Next, the transparent insulating substrate 41 on which the first transparent electrode 42 has been formed is placed as a treatment target on the positive electrode of the plasma-enhanced CVD device. The transparent insulating substrate 41 held by the positive electrode is accommodated in a reaction container, which is then evacuated. Thereafter, a material gas (SiH₄ and H₂) and a p-type impurity gas are introduced into the reaction container to form the microcrystalline p-type silicon layer 43 on the first transparent electrode 42. The p-type impurity gas may be, for example, B₂H₆. Next, after the formation of the p-type silicon layer 43, the transparent insulating substrate 41 is accommodated in a reaction container of another plasma-enhanced CVD device, which is then evacuated. Thereafter, a mixture gas of SiH₄ and H₂ (material gas) is introduced into the reaction container to form the microcrystalline i-type silicon layer 44 on the p-type silicon layer 43.

Next, after the formation of the i-type silicon layer 44, the supply of the material gas is stopped, and the reaction container is evacuated. Thereafter, the transparent insulating substrate 41 is accommodated in another evacuated reaction container, and a material gas (SiH₄ and H₂) and an n-type impurity gas are introduced into the reaction container, which is then controlled to a predetermined pressure. The n-type impurity gas may be, for example, PH₃. The microcrystalline n-type silicon layer 45 is formed on the i-type silicon layer 44. Next, after the formation of the n-type silicon layer 45, the supply of the material gas is stopped, and the reaction container is evacuated. Thereafter, the transparent insulating substrate 41 on which the n-type silicon layer 45 etc. have been formed is accommodated in a DC sputtering device to form the second transparent electrode 46 on the n-type silicon layer 45 in the DC sputtering device. Thereafter, the back electrode 47 is formed on the second transparent electrode 46 by sputtering. Thus, the solar cell 200 is manufactured. When a thin film solar cell is employed as the photoelectric conversion layer, the silicon thin film technology required for fabrication of a liquid crystal display panel can also be applied to the solar cell, and therefore, the liquid crystal display system including the solar cell can be efficiently manufactured.

Next, the second transparent substrate 12 of the liquid crystal display panel 100 and the transparent insulating substrate 41 of the solar cell 200 are positioned to face each other so that the liquid crystal display panel 100 and the solar cell 200 are joined together. The liquid crystal display panel 100 and the solar cell 200 may be joined together directly or with a spacer being interposed therebetween. Thus, the solar panel 900 is manufactured.

Next, an example application of the solar panel 900 will be described. Here, in the example, when the solar cell 200 does not perform power generation, the liquid crystal display panel 100 displays a digital signage content received via the Internet.

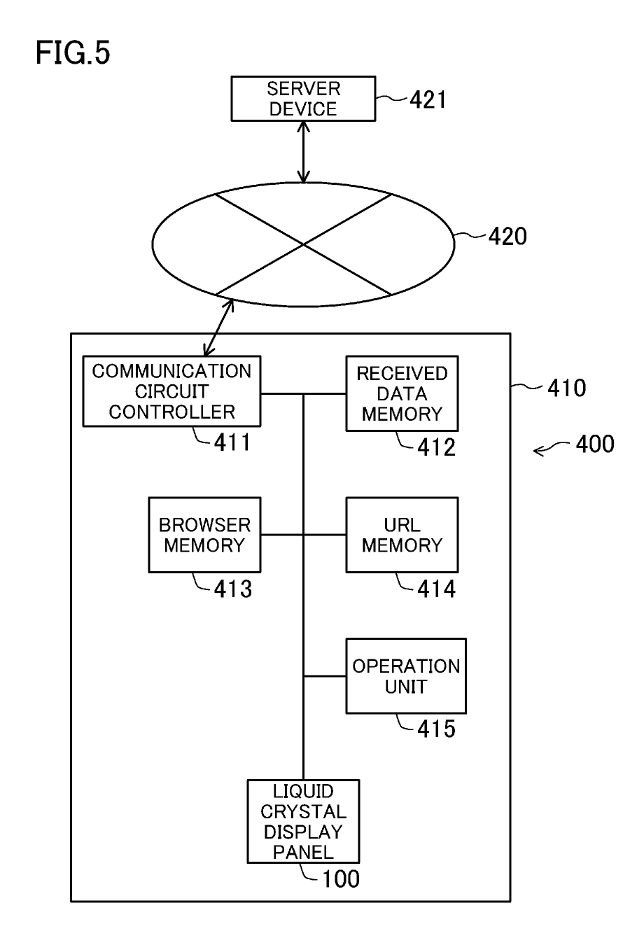

Firstly, a digital signage system will be briefly described. FIG. 5 is a block diagram of the digital signage system 400 using the Internet. As shown in FIG. 5, the digital signage system 400 includes an electronic sign device 410, and a dedicated server device 421 connected to the Internet 420. The electronic sign device 410 is placed, for example, above an entrance of a shop or office, to display contents, such as advertisements, information for employees, etc.

A communication circuit controller 411 connects the electronic sign device 410 to the server device 421 via the Internet 420. Contents are provided and received from the server device 421 by automatic distribution or by operating the electronic sign device 410 to input a predetermined URL from the URL memory 414 or manually operating an operation unit 415, and thereby connecting the dedicated server device 421. The received content data is temporarily stored in a received data memory 412. A browser memory 413 stores browser software which generates a predetermined display screen image based on the received content. The content is displayed on the liquid crystal display panel 100 as follows. The operation unit 415 is operated to select and read a required content from the received data memory 412, and a display screen signal is generated based on the content data and is displayed on the liquid crystal display panel 100.

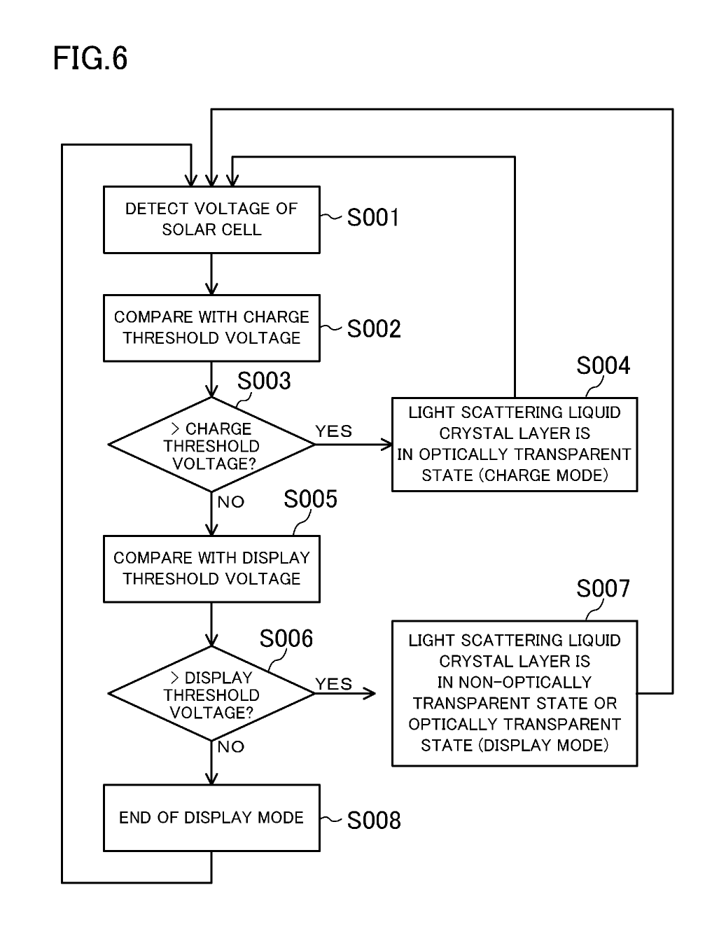

Next, an example use of the solar panel 900 will be described. FIG. 6 is a flowchart of the example use in which the charge mode and the display mode are switched based on comparison of the generated voltage of the solar cell and the threshold voltage. In this embodiment, the generated voltage detected by the voltage detector 201 is compared with the predetermined threshold voltage. If the detected generated voltage is higher than the threshold voltage, the charge mode is selected. If the detected generated voltage is lower than the threshold voltage, the display mode is selected. A detailed control will be described hereinafter.

As shown in FIGS. 1 and 6, the voltage detector 201 detects the voltage generated by the solar cell 200 (S001). The detected voltage is transferred to the mode switch 321. The mode switch 321 compares the detected voltage with a predetermined charge threshold voltage (S002). The predetermined charge threshold voltage is used to determine whether or not the detected voltage is a voltage which is generated by the solar cell 200 during the day. The comparison of the detected voltage and the predetermined charge threshold voltage is performed by determining whether or not the detected voltage is higher than the charge threshold voltage (S003).

If the detected voltage is higher than the charge threshold voltage, it is determined that it is in a time period in which the solar cell 200 performs power generation, and the mode switch 321 causes the liquid crystal controller 320 to control the memory liquid crystal layer 36 so that the memory liquid crystal layer 36 is set to or maintained in the optically transparent state (S004). Thereafter, the voltage detector 201 continues to monitor the voltage generated by the solar cell 200, and control returns to S001.

Next, if the detected voltage is lower than the charge threshold voltage, the detected voltage is compared with the predetermined display threshold voltage (S005). When the liquid crystal display panel 100 displays an image (second mode), the memory liquid crystal layer 36 in a predetermined portion of the liquid crystal display panel 100 is caused to be in the optically transparent state to perform dark display, and therefore, light passing through the memory liquid crystal layer 36 in the optically transparent state illuminates the solar cell 200, and therefore, a voltage can be detected in the solar cell 200. The predetermined display threshold voltage may be, for example, a voltage which is detected when the liquid crystal display panel 100 displays a light-and-dark image around sunset or sunrise etc., and is lower than the charge threshold voltage. The comparison of the detected voltage and the predetermined display threshold voltage is performed by determining whether or not the detected voltage is higher than the display threshold voltage (S006).

If the detected voltage is higher than the display threshold voltage, it is determined that it is in a time period in which the liquid crystal display panel 100 displays a light-and-dark image, and the mode switch 321 causes the liquid crystal controller 320 to control the state of the memory liquid crystal layer 36 so that dark display is performed in a predetermined portion of the liquid crystal display panel 100 and light display is performed at the other portion (S007). Thereafter, the voltage detector 201 continues to monitor the voltage generated by the solar cell 200, and control returns to S001.

On the other hand, if the detected voltage is lower than the display threshold voltage, it is determined that the time period in which the liquid crystal display panel 100 displays a light-and-dark image has been ended, and the mode switch 321 stops issuing a liquid crystal control instruction for displaying a light-and-dark image to the liquid crystal controller 320. The control of the liquid crystal alignment of the memory liquid crystal layer 36 after the end of the display mode may be appropriately set. In order to facilitate detection of the display threshold voltage again after the end of the display mode, the memory liquid crystal layer 36 is preferably set to the optically transparent state.

Note that if the detected voltage is equal to the threshold voltage in S003 or S007, the solar panel 900 can be appropriately set to either the charge mode or the display mode.

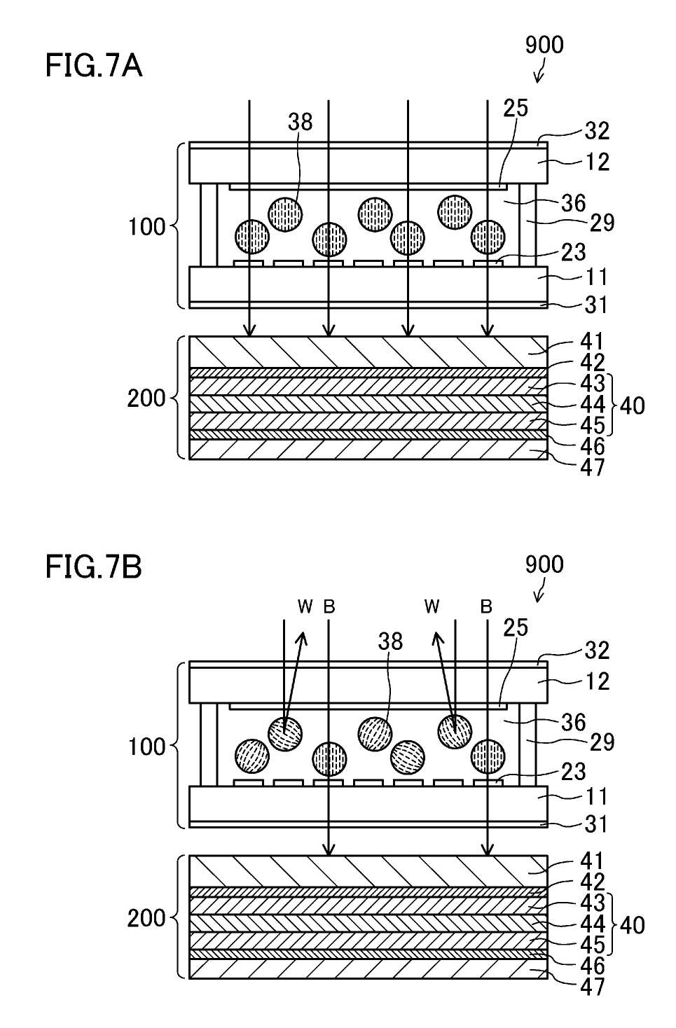

Next, operation of the solar panel 900 will be described with reference to FIGS. 7A and 7B. FIG. 7A is a cross-sectional view for describing how the solar cell 200 performs power generation (first mode). FIG. 7B is a cross-sectional view for describing how the liquid crystal display panel 100 displays an image while the solar cell 200 does not perform power generation (second mode).

As shown in FIG. 7A, when the solar cell 200 performs power generation, for example, during the day, the liquid crystal controller 320 applies a voltage between the pixel electrode 23 and the counter electrode 25 to cause liquid crystal molecules 38 in the memory liquid crystal layer 36 to be in an aligned state, whereby the memory liquid crystal layer 36 of the liquid crystal display panel 100 is changed to the optically transparent state. As a result, external light (e.g., sunlight etc.) is transmitted through the memory liquid crystal layer 36 to enter through the transparent insulating substrate 41 into the photoelectric conversion layer 40, which in turn converts the light into electricity, whereby sufficient power is generated.

On the other hand, as shown in FIG. 7B, when the solar cell 200 does not perform power generation, for example, during the night (after sunset), the liquid crystal controller 320 does not apply a voltage between the pixel electrode 23 and the counter electrode 25 in a predetermined portion of the liquid crystal display panel 100, and thereby causes the liquid crystal molecules 38 in the memory liquid crystal layer 36 to be in a random state. As a result, the memory liquid crystal layer 36 is changed to the light scattering state in which external light is scattered so that light display (e.g., white display W) is performed in the predetermined portion of the liquid crystal display panel 100. At the same time, the liquid crystal controller 320 applies a voltage between the pixel electrode 23 and the counter electrode 25 in the other portion of the liquid crystal display panel 100 to cause the liquid crystal molecules 38 in the memory liquid crystal layer 36 to be the aligned state. As a result, the memory liquid crystal layer 36 of the liquid crystal display panel 100 is changed to the optically transparent state, whereby dark display (e.g., black display B) based on the color of the solar cell 200 is performed on the liquid crystal display panel 100.

Thus, based on a content transmitted from the server device 421, an image including a combination of light display and dark display is formed on the liquid crystal display panel 100. Images which the liquid crystal display panel 100 can display include characters, numerals, symbols, graphics, or a combination thereof.

Note that when the photoelectric conversion layer 40 is formed of amorphous silicon, dark display based on the color of the solar cell 200, which is obtained by forming pixels in the optically transparent state, is brown display. When the photoelectric conversion layer 40 is of the tandem type, the color of the solar cell can be caused to be closer to black than when the photoelectric conversion layer 40 is formed of microcrystalline silicon, and therefore, the contrast ratio of dark display and light display can be further improved.

Driving of an active matrix thin film transistor when the liquid crystal display panel 100 displays a content will be described with reference to FIG. 3. When the scanning line drive circuit 110 outputs a scanning signal to successively turn on the scanning lines 22, thereby sampling video signals to the signal lines 21 in synchronization with the scanning, all thin film transistors 24 connected to the scanning line 22 in the on state are on only during one horizontal scanning period, and the video signals sampled to the signal lines 21 are written via the thin film transistors 24 to the pixel electrodes 23. The video signal is stored as a signal voltage between the pixel electrode 23 and the counter electrode 25, and the memory liquid crystal layer 36 is caused to be in the aligned state or the random state, depending on the presence or absence (i.e., the magnitude) of the signal voltage, whereby each display pixel 80 is controlled to light display or dark display. Such operation is performed for all of the scanning lines 22 during one frame period, whereby a video content is displayed.

According to this embodiment, when the solar cell 200 performs power generation, the memory liquid crystal layer 36 of the liquid crystal display panel 100 is caused to be transparent so that sufficient light enters the solar cell 200 and therefore the solar cell 200 efficently performs power generation. On the other hand, when the solar cell 200 does not perform power generation, the liquid crystal display panel 100 displays an image including a combination of light display and dark display. Therefore, the solar panel 900 can be sufficiently effective as an information medium for advertising, announcement, etc. without a decrease in the efficiency of power generation by the solar cell 200.

Note that when the liquid crystal display panel 100 of FIG. 7B displays an image (second mode), the present invention is not limited to the case where the solar cell 200 does not perform power generation at all. The solar cell 200 may slightly perform power generation using light which is transmitted through the memory liquid crystal layer of the liquid crystal display panel 100 and illuminates the solar cell 200.

### Second Embodiment

In the first embodiment, the voltage generated by the solar cell 200 is monitored so that the solar panel 900 is switched between the charge mode and the display mode. However, the scope of the present invention is not limited to such an embodiment. In a second embodiment, if the time detected by a time detector 202 is in a predetermined time period, a solar panel 900 is set to the charge mode, and otherwise, the solar panel 900 is set to the display mode. This control will be described in greater detail hereinafter.

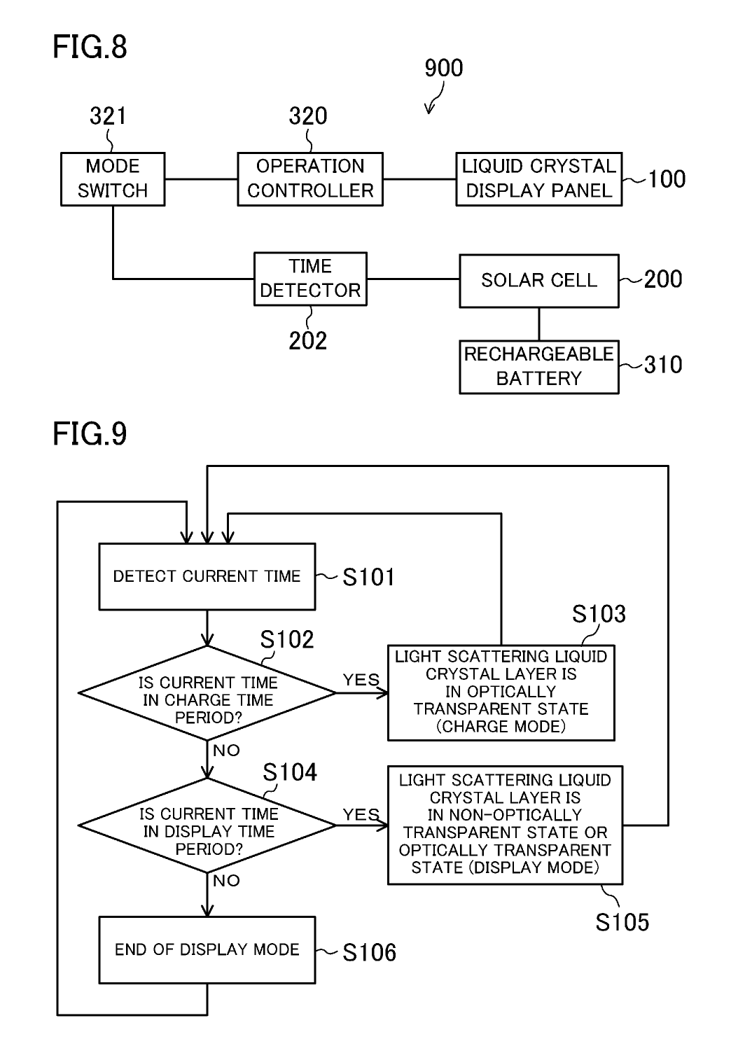

FIG. 8 is a block diagram for briefly describing the solar panel 900 which is switched between the charge mode and the display mode, depending on the time. Although the solar panel 900 of the first embodiment of FIG. 1 includes the voltage detector 201, the solar panel 900 of the second embodiment includes the time detector 202.

FIG. 9 is a flowchart of an example use in which the current time is detected so that the solar panel is switched between the charge mode and the display mode. As shown in FIGS. 8 and 9, the time detector 202 detects the time in a place where the solar panel 900 is placed (S101). Next, the detected time is transferred to a mode switch 321. The mode switch 321 determines whether or not the detected time is in a predetermined charge time period (S102). The predetermined charge time period is, but not particularly limited to, one during which there is enough sunshine to allow the solar cell 200 to charge the rechargeable battery 310. The predetermined charge time period may be appropriately set, taking into consideration a region, a season, etc. in which the solar panel 900 is placed. For example, the predetermined charge time period is from a particular point around sunrise to a particular point around sunset.

If the detected time is in the charge time period, it is determined that it is in the time period during which the solar cell 200 performs power generation. In this case, the mode switch 321 causes the liquid crystal controller 320 to control the memory liquid crystal layer 36 to the optically transparent state (S103). Thereafter, the time detector 202 continues to monitor the current time, and control returns to S101.

On the other hand, if the detected time is not in the predetermined charge time period, it is determined whether or not the detected time is in a predetermined display time period (S104). The predetermined display time period is, but not particularly limited to, one during which the intensity of external light is not high enough to allow the solar cell 200 to charge the rechargeable battery 310, and is high enough to allow the liquid crystal display panel 100 to perform light display using scattered light. For example, the predetermined display time period is one during sunset or sunrise.

If the detected time is in the display time period, the mode switch 321 causes the liquid crystal controller 320 to control the memory liquid crystal layer 36 so that the memory liquid crystal layer 36 performs dark display in a predetermined portion of the liquid crystal display panel 100 and light display in the other portion (S105). Thereafter, the time detector 202 continues to monitor the current time, and control returns to S101.

On the other hand, if the detected time is not in the display time period, it is determined that the time period during which the liquid crystal display panel 100 displays a light-and-dark image has been ended. In this case, the mode switch 321 stops issuing a liquid crystal control instruction for displaying a light-and-dark image to the liquid crystal controller 320. The control of the liquid crystal alignment of the memory liquid crystal layer 36 after the end of the display mode may be appropriately set. In order to facilitate detection of the display time period again after the end of the display mode, the memory liquid crystal layer 36 is preferably set to the optically transparent state.

Note that if the detected time is equal to a time point at the boundary between the charge time period and the display time period, the solar panel 900 can be appropriately set to either the charge mode or the display mode.

### Third Embodiment

In the first embodiment, when the solar cell 200 does not perform power generation, an image is displayed which is a combination of light display performed by scattering external light and dark display performed by passing external light. If the overall intensity of external light illuminating the liquid crystal display panel 100 is low, light display performed by scattered light is blurred, and therefore, the contrast ratio decreases. Therefore, in the third embodiment, a backlight including a plurality of light emitting units is used to illuminate a light display portion, whereby the decrease of the contrast ratio is reduced or prevented even when the intensity of external light is low.

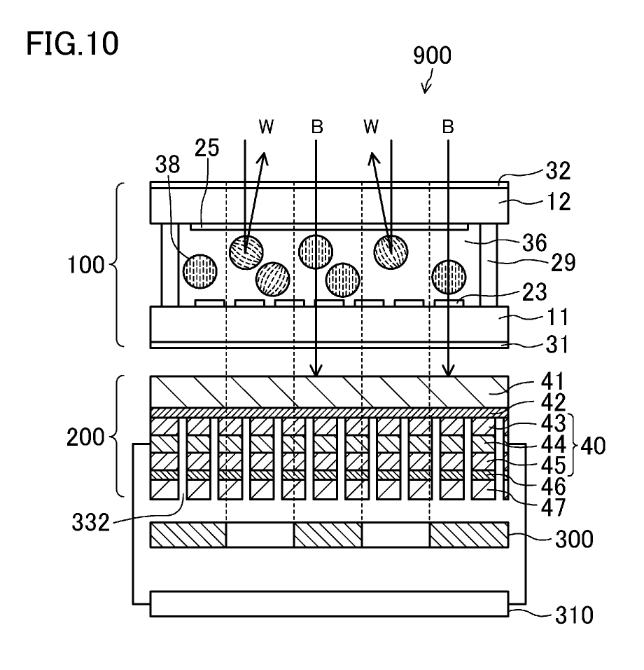

FIG. 10 is a diagram for describing a display form in which a backlight 300 including a plurality of light emitting units is provided, and a light emitting unit(s) corresponding to a portion in which dark display is formed is turned off while a light emitting unit(s) corresponding to a portion in which light display is formed is turned on. As shown in FIG. 10, a solar panel 900 of the third embodiment includes the backlight 300 including a plurality of light emitting units (e.g., fluorescent tubes etc.) which is provided on the back side, facing the liquid crystal display panel 100, and emits illuminating light to the liquid crystal display panel 100, and an on/off controller (not shown) which controls on and off of the light emitting unit. A rechargeable battery 310 which stores power generated by a solar cell 200 is connected to the solar cell 200. The solar cell 200 of the third embodiment is of a light transmission type. Specifically, the solar cell 200 has a plurality of slit-shaped openings 332 for passing illuminating light emitted from the backlight 300 toward the liquid crystal display panel 100. The opening 332 is formed to penetrate a back electrode 47, a second transparent electrode 46, and a photoelectric conversion layer 40 in a direction in which the liquid crystal display panel 100 and the backlight 300 are aligned. The openings 332 all have the same cross-sectional shape as taken along a plane perpendicular to the direction in which the liquid crystal display panel 100 and the backlight 300 are aligned.

The openings 332 may be formed, for example, by irradiation with YAG laser through a transparent insulating substrate 41 using a mask. The irradiation with YAG laser is performed under conditions that the first transparent electrode 42 is not damaged.

The solar cell 200 generates power not only from external light (e.g., sunlight etc.) but also from light emitted by the backlight 300. The generated power is stored into the rechargeable battery 310. The backlight 300 is driven by the power stored in the rechargeable battery 310. A light emitting unit of the backlight 300 corresponding to a portion of the liquid crystal display panel 100 in which dark display (e.g., black display B) is formed is turned off while a light emitting unit of the backlight 300 corresponding to a portion of the liquid crystal display panel 100 in which light display (e.g., white display W) is formed is turned on.

Specifically, the liquid crystal molecules 38 in the memory liquid crystal layer 36 are caused to be in the random state, so that the memory liquid crystal layer 36 is changed to the light scattering state, whereby external light is scattered to perform light display. If the overall intensity of external light incident to the liquid crystal display panel 100 is low, the intensity of scattered light is also low, and therefore, light display is blurred and weak. Therefore, if the light emitting unit of the backlight 300 corresponding to a portion where light display is formed is turned on, the light of the backlight 300 is scattered by the liquid crystal molecules 38 in the random state to generate scattered light. The light display is supplemented by this scattered light, whereby the contrast of the light display and the dark display can be emphasized.

The rechargeable battery 310 is connected to the solar cell 200. Power generated by the solar cell 200 is stored in the rechargeable battery 310. The power stored in the rechargeable battery 310 is supplied to the backlight 300, which in turn illuminates the solar cell 200. As a result, the solar cell 200 is illuminated with light emitted by the backlight 300 as well as sunlight, and electrical energy generated by the light is used to emit illuminating light. Thus, a self-contained power generation system can be obtained.

### Fourth Embodiment

When a part of the display portion 90 of the liquid crystal display panel 100 is illuminated with external light, the intensity of external light may vary from region to region, and in this case, it is difficult to provide satisfactory display. For example, while the intensity of external light is high and therefore light display is emphasized due to scattering of the external light in a part of the display portion 90, normal light display is performed by scattering of external light in the other region. Therefore, in a fourth embodiment, a plurality of photosensors are provided in the display portion 90 to detect the intensity of external light in each predetermined region of the display portion 90, and based on the detection result, satisfactory display is performed irrespective of illumination conditions of external light.

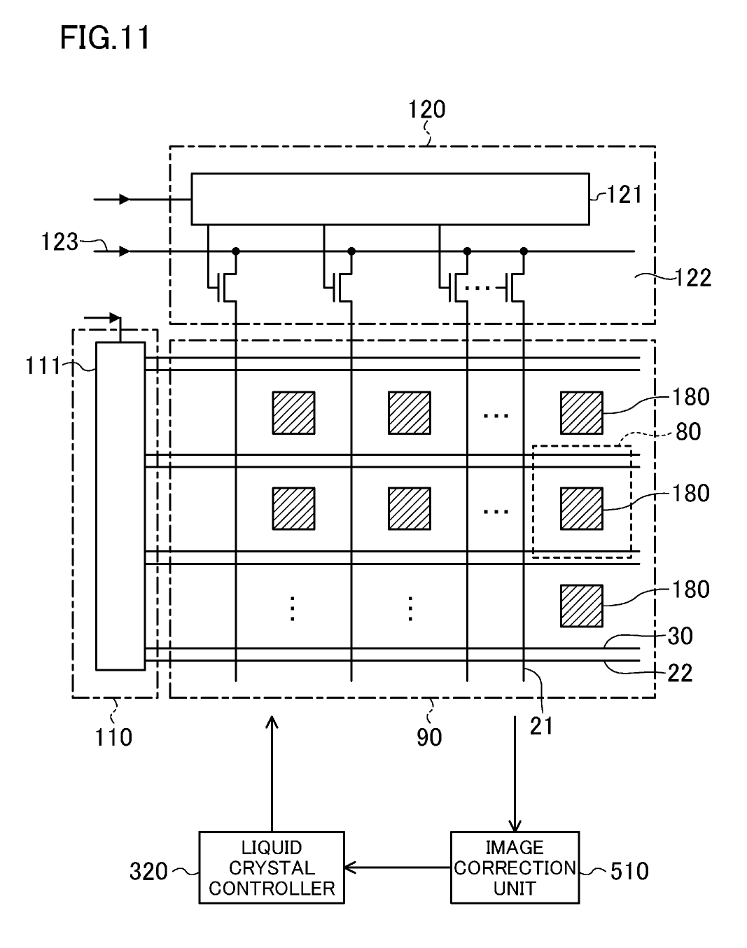

FIG. 11 is a block diagram for describing a configuration in which a plurality of photosensors are provided in the display portion 90 of the liquid crystal display panel 100. A photosensor 180 is provided for each predetermined region of the display portion 90, and therefore, the intensity of external light illuminating the display portion 90 is detected in each predetermined region. The display portion 90 is divided into x×y regions (x in the width direction (horizontal direction) and y in the length direction (vertical direction)), and a total of x×y photosensors 180 are provided. For example, one photosensor 180 is provided for each pixel formation portion, i.e., for each region corresponding to one pixel of the display portion 90. An image correction unit 510 corrects an image displayed in the display portion 90, based on the distribution of the intensity of external light in the display portion 90 which is obtained based on the detection results of the photosensors 180.

A data signal of an image to be displayed is supplied as an external input signal to the liquid crystal controller 320. A detection value indicating the intensity of external light obtained in each region of the display portion 90 by the corresponding photosensor 180 is input to the image correction unit 510. The image correction unit 510 corrects an image signal corresponding to the external data signal based on the detection values of the intensity of external light. Specifically, in a region having a high external light intensity, the liquid crystal molecules 38 of the memory liquid crystal layer 36 are changed from the random state to an aligned state in which the liquid crystal molecules 38 are slightly optically transparent. Here, the term “aligned state in which the liquid crystal molecules 38 are slightly optically transparent” means that the light transmission is, but not limited to, for example, [T₁+0.2(T₂−T₁)]% to [T₁+0.4(T₂−T₁)]%, where T₁% is the light transmission of the liquid crystal molecules in the random state, and T₂% is the light transmission of the liquid crystal molecules in the aligned state (note that T₂>T₁). As a result, even in a region having a high external light intensity, the liquid crystal molecules 38 are aligned to a slightly optically transparent state, i.e., a slightly dark state, whereby the emphasis on light display can be reduced. Therefore, even if the intensity of external light varies from position to position in the display portion 90, the user can view an image having an original or intended contrast over the entire screen.

Note that, in this embodiment, the photosensors 180 are provided in the display portion 90 of the liquid crystal display panel 100, and the present invention is not limited to such an arrangement of the photosensors 180. The photosensors 180 may be provided in a frame portion of the liquid crystal display panel 100 instead of the display portion 90, in order to improve the light transmission.

### Fifth Embodiment

In the fourth embodiment, the photosensors 180 are provided in the display portion 90 to detect the intensity of external light in each predetermined region of the display portion 90, and in a region having a high external light intensity, the liquid crystal molecules 38 are changed from the random state to an aligned state in which the liquid crystal molecules 38 are slightly optically transparent, whereby the emphasis on light display is reduced, and therefore, the user can view an image having an original or intended contrast over the entire screen. The scope of the present invention is not limited to such an embodiment.

In this embodiment, as in the fourth embodiment, a plurality of photosensors 180 are provided in the display portion 90 of the liquid crystal display panel 100. Moreover, as in the third embodiment, a backlight 300 including a plurality of light emitting units which illuminate the solar cell 200, and an on/off controller which controls on and off of each light emitting unit, are provided. The solar cell 200 is of a light transmission type as in the third embodiment, and specifically, includes a plurality of slit-shaped openings.

The intensity of external light is detected in each region of the display portion 90 by the corresponding photosensor 180. In a region having a low external light intensity, the on/off controller controls and turns on the light emitting unit(s) of the backlight 300 corresponding to that region. Specifically, the light emitting unit(s) corresponding to a region(s) having a low external light intensity is turned on while the light emitting unit(s) corresponding to the other region(s) is turned off. Alternatively, the intensity of the light emitting unit(s) corresponding to a region(s) having a low external light intensity is caused to be higher than the intensity of the light emitting unit(s) corresponding to the other region(s). As a result, light of the backlight 300 is scattered by the liquid crystal molecules 38 in the random state to generate scattered light, whereby light display is supplemented in a region(s) having a low external light intensity, and therefore, the contrast of light display and dark display can be emphasized.

### Sixth Embodiment

In the above embodiments, when the solar cell 200 does not perform power generation, an image including a combination of light display and dark display is formed on the liquid crystal display panel 100. However, because light display is performed by scattering external light, an image cannot be displayed, for example, during the night, at which there is not external light. Therefore, in a sixth embodiment, an LED illumination unit 330 is provided so that an image is displayed on the liquid crystal display panel 100 using LED light except in the first and second modes.

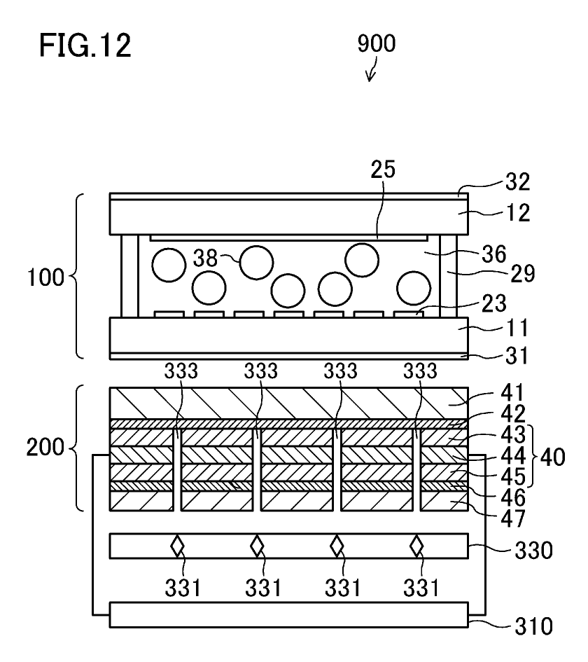

FIG. 12 is a diagram for describing a configuration in which the LED illumination unit 330 is formed on the back side of the solar cell 200 so that an image is displayed using LED light. As shown in FIG. 12, in the sixth embodiment, the LED illumination unit 330 including a plurality of LED elements 331 is provided on the back side of the solar cell 200, facing the solar cell 200. The LED elements 331 included in the LED illumination unit 330 emit light beams having three primary colors (R, G, and B), whereby not only color display can be performed, but also a white color can be displayed by simultaneously emitting light beams having three primary colors (R, G, and B).

Openings 333 corresponding to the respective LED elements 331 are formed in the solar cell 200. The openings 333 penetrate the back electrode 47, the second transparent electrode 46, and the photoelectric conversion layer 40 in a direction in which the liquid crystal display panel 100 and the backlight 300 are aligned. The openings 333 all have the same cross-sectional shape as taken along a plane perpendicular to the direction in which the liquid crystal display panel 100 and the backlight 300 are aligned. Each LED element 331 is provided directly below the corresponding opening 333. Alternatively, the LED element 331 may be provided every other opening 333 or between each opening 333. The openings 333 may be formed, for example, by irradiation with laser through the transparent insulating substrate 41 as in the third embodiment.

The LED element are connected to an LED control circuit (not shown) which controls on and off of each LED element. A rechargeable battery 310 is connected to the solar cell 200 and stores power generated by the solar cell 200. The power stored in the rechargeable battery 310 is supplied to the LED illumination unit 330, and the LED elements 331 are driven by the power stored in the rechargeable battery 310.

In a solar panel 900 of this embodiment, an image can be displayed on the liquid crystal display panel 100, for example, during the night, by turning on or off each LED element 331. Specifically, an image can be displayed by controlling on and off of the LED elements 331 separately. For example, an image of a symbol indicating good weather (sunny) is displayed to announce tomorrow's weather, or emoticons are displayed for adverting. Display using LED light may be performed, for example, after the end of the display mode shown in S008 of FIG. 6 or after the end of the display mode shown in S106 of FIG. 9.

LED light is transmitted from the back side through the openings 333 to the front side, whereby an image is displayed while the directivity of the LED light is maintained. Therefore, the memory liquid crystal layer 36 is preferably set to the optically transparent state. However, if image display is not substantially disturbed even when LED light is more or less scattered, the memory liquid crystal layer 36 can be set to the light scattering state.

According to this embodiment, display can be performed using LED light even during the night, and therefore, the solar panel 900 can be promoted as an information medium for advertising, announcement, etc. Moreover, the LED element 331 is turned on by power which is generated by the solar cell 200 and stored in the rechargeable battery 310, and therefore, the solar panel 900 is advantageous in terms of energy saving.

### Seventh Embodiment

In the above embodiments, the solar cell 200 is a silicon solar cell. The scope of the present invention is not limited to such embodiments. In a seventh embodiment, the solar cell 200 is a dye-sensitized solar cell.

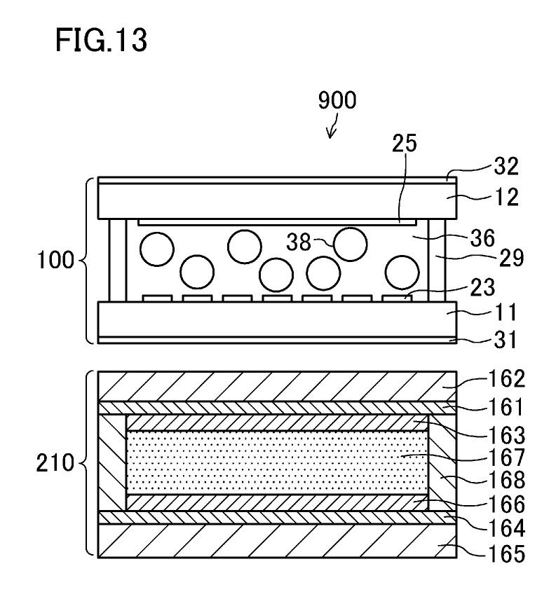

FIG. 13 is a cross-sectional view of a solar panel 900 in which a dye-sensitized solar cell 210 is provided on the back side of a liquid crystal display panel 100, facing the liquid crystal display panel 100. As shown in FIG. 13, the dye-sensitized solar cell 210 includes a transparent substrate 162 on which a transparent conductive film 161 is formed, and an optical electrode 163 containing a sensitized dye and a titanium oxide semiconductor. The optical electrode 163 is electrically connected to the transparent conductive film 161. The optical electrode 163 is formed of, for example, a titanium oxide semiconductor. Examples of the titanium oxide semiconductor include, but are not limited to, titanium oxide, anatase-type titanium oxide, etc. A counter substrate 165 on which a conductive layer 164 is formed is provided and separated from the transparent conductive film 161, facing the transparent conductive film 161. A counter electrode 166 is formed in contact with the conductive layer 164 of the counter substrate 165. The counter electrode 166 is formed of, for example, a metal (e.g., gold, platinum, silver, copper, magnesium, aluminum, indium, etc.), carbon, a conductive metal oxide (e.g., indium-tin composite oxide, fluorine-doped tin oxide, etc.), etc. A space between the counter electrode 166 and the optical electrode 163 is filled with an electrolyte solution 167. The electrolyte solution 167 results from dissolution of iodine, lithium iodide, tertiary butyl pyridine, and dimethyl propylimidazolium iodide in methoxy acetonitrile or acetonitrile. An outer circumferential surface of the optical electrode 163 and the counter electrode 166 is sealed by a sealing layer 168.

When sunlight enters through the transparent substrate 162, the sensitized dye of the optical electrode 163 absorbs the energy of the light to be excited and emit electrons. The emitted electrons flow through the titanium oxide semiconductor to the transparent conductive film 161 and then to an external circuit. In this case, positive ions of the sensitized dye which has emitted electrons oxidize iodine ions of the electrolyte solution 167. The oxidized iodine ions are reduced by electrons which are returned from the external circuit to the counter electrode 166. By thus circulating electrons, the dye-sensitized solar cell 210 functions as a cell. By appropriately selecting the sensitized dye adsorbed by the optical electrode 163, various colors can be imparted to the dye-sensitized solar cell 210. Therefore, dark display is capable of being designed. Note that, unlike the above configuration, a tandem-type dye-sensitized solar cell may be provided which includes a first electrode adsorbing a first sensitized dye, a second electrode adsorbing a second sensitized dye having an absorption wavelength different from that of the first sensitized dye, and a counter electrode interposed between the first and second electrodes.

### Other Embodiments

In the above embodiments, the solar panels 900 have been described. The present invention has a basic configuration as follows. A liquid crystal display panel including a light scattering liquid crystal layer interposed between substrates is provided on the front side of a solar cell. When the solar cell performs power generation, a light scattering liquid crystal layer in the liquid crystal display panel is changed to the optically transparent state. On the other hand, when the liquid crystal display panel displays an image, pixels in the light scattering state are formed to scatter incident light, whereby light display is performed in a predetermined portion of the liquid crystal display panel while pixels in the optically transparent state are formed, whereby dark display is performed in the other portion of the liquid crystal display panel. Thus, an image including a combination of the light display and the dark display is formed on the liquid crystal display panel. The solar panel 900 may be considered as a solar panel with a display function or a liquid crystal display system with a solar cell. Therefore, the above embodiments may be configured as a liquid crystal display system.

In the above example application, the solar panels 900 of the above embodiments are placed on a wall of an office building. The solar panels 900 of the above embodiments are, of course, used in other applications, such as transit advertising, signs in stations, vending machines, warning display devices, guidance display devices, traffic signs, light-emitting display devices, etc.

### INDUSTRIAL APPLICABILITY

The solar panel of the present invention can be satisfactorily used as an information medium for advertising, announcement, etc. without a decrease in power generation of the solar cell, and therefore, is preferably used at places where a crowd gathers, such as walls of office buildings and stations.

### DESCRIPTION OF REFERENCE CHARACTERS

11 FIRST TRANSPARENT SUBSTRATE
12 SECOND TRANSPARENT SUBSTRATE
21 SIGNAL LINE
22 SCANNING LINE
23 PIXEL ELECTRODE
24 THIN FILM TRANSISTOR
25 COUNTER ELECTRODE
29 SEALING MATERIAL
30 CONTROL SIGNAL LINE
31 LOWER POLARIZING PLATE
32 UPPER POLARIZING PLATE
36 MEMORY LIQUID CRYSTAL LAYER
38 LIQUID CRYSTAL MOLECULE
41 TRANSPARENT INSULATING SUBSTRATE
42 FIRST TRANSPARENT ELECTRODE
43 p-TYPE SILICON LAYER
44 i-TYPE SILICON LAYER
45 n-TYPE SILICON LAYER
46 SECOND TRANSPARENT ELECTRODE
47 BACK ELECTRODE
80 DISPLAY PIXEL
90 DISPLAY PORTION
100 LIQUID CRYSTAL DISPLAY PANEL
110 SCANNING LINE DRIVE CIRCUIT
111, 121 SHIFT REGISTER
120 SIGNAL LINE DRIVE CIRCUIT
122 ANALOG SWITCH
161 TRANSPARENT CONDUCTIVE FILM
162 TRANSPARENT SUBSTRATE
163 OPTICAL ELECTRODE
164 CONDUCTIVE LAYER
165 COUNTER SUBSTRATE
166 COUNTER ELECTRODE
167 ELECTROLYTE SOLUTION
168 SEALING LAYER
180 PHOTOSENSOR
200 SOLAR CELL
201 VOLTAGE DETECTOR
202 TIME DETECTOR
210 DYE-SENSITIZED SOLAR CELL
300 BACKLIGHT
310 RECHARGEABLE BATTERY
320 LIQUID CRYSTAL CONTROLLER
321 MODE SWITCH
330 LED ILLUMINATION UNIT
331 LED ELEMENT
332, 333 OPENING
410 ELECTRONIC SIGN DEVICE
411 COMMUNICATION CIRCUIT CONTROLLER
412 RECEIVED DATA MEMORY
413 BROWSER MEMORY
414 URL MEMORY
420 INTERNET
510 IMAGE CORRECTION UNIT
900 SOLAR PANEL

1. A solar panel comprising:
a liquid crystal display panel including a first transparent substrate on which a first electrode is formed, a second transparent substrate on which a second electrode is formed and which faces the first transparent substrate, and a light scattering liquid crystal layer enclosed between the first and second transparent substrates;
a solar cell provided on a back side of the liquid crystal display panel, facing the liquid crystal display panel; and
a liquid crystal controller configured to control an aligned state of liquid crystal, wherein
the liquid crystal controller, in a first mode in which the solar cell performs power generation, causes the light scattering liquid crystal layer of the liquid crystal display panel to be in an optically transparent state so that external light is transmitted through the light scattering liquid crystal layer to illuminate the solar cell, and
the liquid crystal controller, in a second mode in which the liquid crystal display panel displays an image, forms an electric field between the first and second electrodes in a predetermined portion of the liquid crystal display panel to cause the light scattering liquid crystal layer to be in the optically transparent state, thereby performing dark display, and does not form an electric field between the first and second electrodes in the other portion of the liquid crystal display panel, to cause the light scattering liquid crystal layer to be in a light scattering state to scatter external light, thereby performing light display, whereby a light-and-dark image including a combination of the light display and the dark display is displayed on the liquid crystal display panel.

2. The solar panel of claim 1, wherein
the solar panel receives data containing at least one of video data and audio data of a digital signage content via the Internet or digital broadcast waves of a broadcast station, and displays the received digital signage content on the liquid crystal display panel.

3. The solar panel of claim 1, comprising:
a rechargeable battery configured to store power generated by the solar cell;
a voltage detector configured to detect a voltage generated by the solar cell; and
a mode switch configured to compare the voltage detected by the voltage detector with a predetermined threshold voltage, and if the detected voltage is higher than the threshold voltage, cause the solar panel to be in a charge mode in which the rechargeable battery is charged with the power generated by the solar cell, and if the detected voltage is lower than the threshold voltage, cause the solar panel to be in a display mode in which the liquid crystal display panel displays an image.

4. The solar panel of claim 1, comprising:
a rechargeable battery configured to store power generated by the solar cell;
a time detector configured to detect current time; and
a mode switch configured to, if the time detected by the time detector is in a predetermined time period, cause the solar panel to be in a charge mode in which the rechargeable battery is charged with the power generated by the solar cell, and if the detected time is not in the predetermined time period, cause the solar panel to be in a display mode in which the liquid crystal display panel displays an image.

5. The solar panel of claim 1, comprising:
a backlight including a plurality of light emitting units provided on a back side of the solar cell, facing the solar cell, and configured to emit illuminating light toward the liquid crystal display panel; and
an on/off controller configured to control on and off of each of the light emitting units,
wherein
the solar cell includes an opening configured to transmit the illuminating light emitted by the backlight toward the liquid crystal display panel, and
the on/off controller, in the second mode, turns off the light emitting unit or units of the backlight corresponding to the other portion of the liquid crystal display panel on which dark display is formed, and turns on the light emitting unit or units of the backlight corresponding to the predetermined portion of the liquid crystal display panel in which light display is formed.

6. The solar panel of claim 1, comprising:
a plurality of photosensors included in the liquid crystal display panel and configured to detect intensity of external light in each predetermined region of a display portion including a plurality of display pixels arranged in a matrix; and
an image correction unit configured to correct an image displayed in the display portion, based on a distribution of the intensity of the external light in the display portion which is obtained based on a result of the detection of the photosensors.

7. The solar panel of claim 1, comprising:
a backlight including a plurality of light emitting units provided on a back side of the solar cell, facing the solar cell, and configured to emit illuminating light toward the liquid crystal display panel;
an on/off controller configured to control on and off of each of the light emitting units; and
a plurality of photosensors included in the liquid crystal display panel and configured to detect intensity of external light in each predetermined region of a display portion including a plurality of display pixels arranged in a matrix,
wherein
the solar cell has an opening configured to transmit the illuminating light emitted by the backlight toward the liquid crystal display panel, and
the on/off controller turns on the light emitting unit or units corresponding to a region for which the corresponding photosensor has detected that the intensity of the external light emitted to the region of the liquid crystal display panel is lower than that in the other region.

8. The solar cell of claim 1, comprising:
an LED illumination unit including a plurality of LED elements provided on a back side of the solar cell, facing the solar cell,
wherein
the solar cell has an opening configured to transmit LED light emitted by the LED element toward the liquid crystal display panel, and
an image is formed on the liquid crystal display panel by illumination with the LED light of the plurality of LED elements through the opening, except in the first and second modes.

9. The solar panel of claim 8, comprising:
a rechargeable battery configured to store power generated by the solar cell, wherein
the LED elements of the LED illumination unit are driven by the power stored in the rechargeable battery.

10. The solar panel of claim 1, wherein
the light scattering liquid crystal layer is a memory liquid crystal layer.

11. The solar panel of claim 1, wherein
the solar cell is a silicon solar cell.

12. The solar panel of claim 1, wherein
the solar cell is a dye-sensitized solar cell.

13. A liquid crystal display system comprising:
a liquid crystal display panel including a first transparent substrate provided on a front side and on which a first electrode is formed, a second transparent substrate on which a second electrode is formed and which is provided on a back side of the first transparent substrate, facing the first transparent substrate, and a light scattering liquid crystal layer enclosed between the first and second transparent substrates;
a liquid crystal controller configured to control an aligned state of liquid crystal; and
a solar cell provided on a back side of the second transparent substrate, facing the second transparent substrate,
wherein
the liquid crystal controller, in a first mode in which the solar cell performs power generation, causes the light scattering liquid crystal layer to be in an optically transparent state so that external light is transmitted through the light scattering liquid crystal layer to illuminate the solar cell, and
the liquid crystal controller, in a second mode in which the liquid crystal display panel displays an image, forms an electric field between the first and second electrodes in a predetermined portion of the light scattering liquid crystal layer to cause the light scattering liquid crystal layer to be in the optically transparent state, thereby performing dark display, and does not form an electric field between the first and second electrodes in the other portion of the light scattering liquid crystal layer, to cause the light scattering liquid crystal layer to be in a light scattering state to scatter external light, thereby performing light display, whereby a light-and-dark image including a combination of the light display and the dark display is displayed.

14. The liquid crystal display system of claim 13, wherein
the liquid crystal display system receives data containing at least one of video data and audio data of a digital signage content via the Internet or digital broadcast waves of a broadcast station, and displays the received digital signage content on the liquid crystal display panel.

15. The liquid crystal display system of claim 1 comprising:
a rechargeable battery configured to store power generated by the solar cell;
a voltage detector configured to detect a voltage generated by the solar cell; and
a mode switch configured to compare the voltage detected by the voltage detector with a predetermined threshold voltage, and if the detected voltage is higher than the threshold voltage, cause the liquid crystal display system to be in a charge mode in which the rechargeable battery is charged with the power generated by the solar cell, and if the detected voltage is lower than the threshold voltage, cause the liquid crystal display system to be in a display mode in which the liquid crystal display panel displays an image.

16. The liquid crystal display system of claim 13, comprising:
a rechargeable battery configured to store power generated by the solar cell;
a time detector configured to detect current time; and
a mode switch configured to, if the time detected by the time detector is in a predetermined time period, cause the liquid crystal display system to be in a charge mode in which the rechargeable battery is charged with the power generated by the solar cell, and if the detected time is not in the predetermined time period, cause the liquid crystal display system to be in a display mode in which the liquid crystal display panel displays an image.

17. The liquid crystal display system of claim 13, comprising:
a backlight including a plurality of light emitting units provided on a back side of the solar cell, facing the solar cell, and configured to emit illuminating light toward the liquid crystal display panel; and
an on/off controller configured to control on and off of each of the light emitting units,
wherein
the solar cell includes an opening configured to transmit the illuminating light emitted by the backlight toward the liquid crystal display panel, and
the on/off controller, in the second mode, turns off the light emitting unit or units of the backlight corresponding to the other portion of the liquid crystal display panel on which dark display is formed, and turns on the light emitting unit or units of the backlight corresponding to the predetermined portion of the liquid crystal display panel in which light display is formed.

18. The liquid crystal display system of claim 13, comprising:
a plurality of photosensors included in the liquid crystal display panel and configured to detect intensity of external light in each predetermined region of a display portion including a plurality of display pixels arranged in a matrix; and
an image correction unit configured to correct an image displayed in the display portion, based on a distribution of the intensity of the external light in the display portion which is obtained based on a result of the detection of the photosensors.

19. The liquid crystal display system of claim 13, comprising:
a backlight including a plurality of light emitting units provided on a back side of the solar cell, facing the solar cell, and configured to emit illuminating light toward the liquid crystal display panel;
an on/off controller configured to control on and off of each of the light emitting units; and
a plurality of photosensors included in the liquid crystal display panel and configured to detect intensity of external light in each predetermined region of a display portion including a plurality of display pixels arranged in a matrix,
wherein
the solar cell has an opening configured to transmit the illuminating light emitted by the backlight toward the liquid crystal display panel, and
the on/off controller turns on the light emitting unit or units corresponding to a region for which the corresponding photosensor has detected that the intensity of the external light emitted to the region of the liquid crystal display panel is lower than that in the other region.

20. The liquid crystal display system of claim 13, comprising:
an LED illumination unit including a plurality of LED elements provided on a back side of the solar cell, facing the solar cell,
wherein
the solar cell has an opening configured to transmit LED light emitted by the LED element toward the liquid crystal display panel, and
an image is formed on the liquid crystal display panel by illumination with the LED light of the plurality of LED elements through the opening except in the first and second modes.

21. The liquid crystal display system of claim 13, wherein
the light scattering liquid crystal layer is a memory liquid crystal layer.

22. A method for controlling a solar panel including a liquid crystal display panel including a first transparent substrate on which a first electrode is formed, a second transparent substrate on which a second electrode is formed and which faces the first transparent substrate, and a light scattering liquid crystal layer enclosed between the first and second transparent substrates, a solar cell provided on a back side of the liquid crystal display panel, facing the liquid crystal display panel, and a liquid crystal controller configured to control an aligned state of liquid crystal, the method comprising:
in a first mode in which the solar cell performs power generation, causing the light scattering liquid crystal layer of the liquid crystal display panel to be in an optically transparent state so that external light is transmitted through the light scattering liquid crystal layer to illuminate the solar cell; and
in a second mode in which the liquid crystal display panel displays an image, forming an electric field between the first and second electrodes in a predetermined portion of the liquid crystal display panel to cause the light scattering liquid crystal layer to be in the optically transparent state, thereby performing dark display, and not forming an electric field between the first and second electrodes in the other portion of the liquid crystal display panel, to cause the light scattering liquid crystal layer to be in a light scattering state to scatter external light, thereby performing light display, and thereby, displaying a light-and-dark image including a combination of the light display and the dark display on the liquid crystal display panel.
